(19) United States
(12) Patent Application Publication
(10) Pub. No.: US 2002/0174141 A1
(43) Pub. Date: Nov. 21, 2002

(54) Method and system for automated data manipulation in an electronic spreadsheet program or the like

(76) Inventor: Shing-Ming Chen, Calgary (CA)

Correspondence Address: SHING-MING CHEN, 132 EDGEBROOK RISE, N.W., CALGARY, T3A 5J5, CA

(21) Appl. No.: 09/681,648

(22) Filed: May 16, 2001

(51) Int. Cl. G06F 15/00

(52) U.S. Cl. 707/503

(57) ABSTRACT

An efficient method and system, which uses a Key Identifier (Key-ID), Region Identifier (Region-ID) and Cell Collection Expression (CCE) to establish a spreadsheet software base for automated data manipulation within an electronic spreadsheet program or the like. A Key-ID is either part of or the entire content of a cell or group of cells drawn from an existing spreadsheet database or inserted into the database by manual prior art spreadsheet data operations or through simple programming. The purpose of the Key-ID is to organize and separate spreadsheet data into manageable data sets of similar construct. The Region-ID is used to specify the region containing the Key-ID and is defined using the Row or Column Identifier (RC-ID) and optional Identifiers-Sheet Identifier, File Identifier, Directory Identifier. The CCE represents or identifies the cell(s) containing the Key-ID within a region of interest specified by the Region-ID and is composed of CCE elements. Each CCE element is a single cell location containing the Key-ID within a manageable data set and is used as a reference point for data manipulation. By assigning a standard coordinate system to each data set with the CCE element as the origin (0,0), the location of the target cells (source and/or destination cells), which must be identified in any spreadsheet data operation, can be specified based on their relative location to the origin in each data set. As each data set can be identified using a single CCE, the fixed relative location of the target cells to the CCE element will allow any spreadsheet data operation to be performed on every data set within the database systematically and automatically by combining the invention with existing spreadsheet capability.

### CROSS REFERENCE TO RELATED APPLICATIONS

U.S. Pat. No. 6,112,214 August, 2000 Graham, et al. 707/503; U.S. Pat. No 5,157,763 October, 2000 Peters, et al. 345/340; U.S. Pat. No. 4,428,065 January, 1984 Duvall, et al. 707/7; Microsoft Excel 97 Online Help Topics; Mastering Lotus SmartSuite, Millennium Edition, 2nd Edition, Sandra E. Eddy, SYBEX Inc.; WordPerfect Office 2000, The Official Guide New for Version 9, Alan Neibauer, Corel Express, Osborne/McGraw-Hill.

### BACKGROUND OF INVENTION

The technical field for the claimed invention is an applied method of automated data manipulation by use of an electronic spreadsheet system or the like.

Spreadsheet software, since its introduction with the advent of personal computers, is a popular computerized method of transforming raw data into meaningful information. With the use of a spreadsheet, which is a two dimensional rectangular grid made up of a finite number of rows and columns and where the intersection of each row and column is referred to as a cell, the user may enter, store and manipulate data.

Although there has been an astonishing improvement in computer hardware (i.e. memory and speed) and software in the past decade, spreadsheet software capability appears to have reached a bottleneck due to the time-consuming iterative step-by-step manual spreadsheet data operations. The user is often required to locate the target cells (source and/or destination cells) and perform spreadsheet data operations repetitiously in order to transform the raw data.

Presently, there is no known technique in the electronic spreadsheet environment to improve this bottleneck. The challenge has been to overcome the difficulties in developing a generalized automated data manipulation tool. These difficulties are mainly due to a lack of method for (a) handling spreadsheet databases that have different format or structure, (b) identifying groups or sets of information or data that require the same type of spreadsheet data operation (i.e. copy, move, insert, etc.), and (c) allowing the user to instruct the computer to carry out all the desired operations throughout the entire database automatically.

### SUMMARY OF INVENTION

The present invention (INV) provides a base to perform an automatic method of data manipulation in an electronic spreadsheet system or the like.

This INV successfully overcomes the lack of method for (a) handling spreadsheet databases that have different format or structure, (b) identifying groups or sets of information or data that require the same type of spreadsheet data operation (i.e. copy, move, insert, etc.), and (c) allowing the user to instruct the computer to carry out all the desired operations throughout the entire database automatically, by combining existing spreadsheet capabilities with the new method and concepts that are derived from this INV.

With this INV, spreadsheet capability can be extended to allow a simple user instruction method to: (1) perform the same kind of spreadsheet data operation(s), such as copy, paste, insert, delete, move, etc., automatically and (2) save a sequence of data operations in a ‘batch job’ and perform the same kind of data operations for any data file by re-executing the ‘batch job’.

Described below are the new concepts and logic that define the method used in this INV:

(1) Key Identifier (Key-ID): The Key-ID is a cell content identifier. It is simply a user defined symbol, number, alphanumeric character or text string (letter, word, phrase, etc.). The Key-ID is the entire content or part of the content of a cell or a group of cells that the user either identifies in the existing database or inserts into the database. The purpose of the Key-ID is to allow a computer program to overcome the difficulties in dealing with databases of different format or structure by separating the database into manageable data sets, in which operations can be performed systematically.

(2) Region Identifier (Region-ID): The Region-ID is a user specified region that contains the Key-ID in the database. The specified region can be defined using one or more parameters depending on where the region is located. If the region is located in the active spreadsheet, only one parameter is needed. In this case a Column or Row Identifier (RC-ID) can be used as the Region-ID. However, if the region extends to sheet(s) outside of the active sheet, the Region-ID requires additional parameters to specify the sheet name, file name, and/or directory name.

(3) Cell Collection Expression (CCE): The CCE uses two different identifiers—Key-ID and Region-ID in a format of Cell(Key-ID,Region-ID). The CCE is used to represent or identify all the cells, which contain the Key-ID in the region specified by the Region-ID. Each cell represented or identified by the CCE is called a CCE element. In this INV, each CCE element is a single cell containing the Key-ID within each data set.

(4) Logic for Systematic Automated Data Manipulation: The logic for systematic automated data manipulation is described in the following steps:

(a) Use the Key-ID to separate the database into several manageable data sets, which have the same data pattern.

(b) Use the Region-ID to specify the region, which contains the Key-ID in the spreadsheet.

(c) Use a Cell Collection Expression (CCE) to represent or identify all the cells containing the Key-ID (each individual cell is a CCE element) in the specified region (Region-ID).

(d) Assign a standard coordinate system with origin (0,0) to the CCE element within each data set.

(e) Given that every data set has the same data pattern, the relative locations of the target cells (source and/or destination cells) with respect to the CCE element origin will be the same for each data set.

(f) With the user specified CCE and the fixed relative locations of the target cells (with respect to the origin), a spreadsheet data operation can easily be performed on one data set after another in a systematic manner throughout the entire database using existing spreadsheet features and macro capability.

(g) The CCE, relative target cells, and type of spreadsheet data operation form a standard input format, which is independent of the number of data sets. This standard input format allows a series of user-specified data operations to be recorded and saved in a “batch job” for future re-execution on any data file.

### BRIEF DESCRIPTION OF DRAWINGS

FIG. 1.0 shows an illustration of a personal computer system having a mouse, keyboard, full display screen, and CPU running an example electronic spreadsheet program.

FIG. 2.0 shows typical electronic spreadsheet windows comprising of a worksheet that has a number of rows and columns, which intersect thus creating the cells within the spreadsheet.

FIG. 3.0 shows a sample spreadsheet with a Key-ID in the original data file, that already has three separate data sets.

FIG. 3.1 shows data in a spreadsheet without an obvious Key-ID.

FIG. 3.2 shows the resulting data spreadsheet with a Key-ID inserted to separate the original database into three data sets.

FIG. 3.3 shows the flow chart of a macro program, which allows the user to insert a Key-ID on the basis of a cell content change.

FIG. 4.0 shows the difference between the Cell Collection Expression (CCE) and conventional spreadsheet reference style for cell identification.

FIG. 5.0 shows the use of the CCE to represent or identify the cells containing the Key-ID in each data set.

FIG. 5.1 shows the assignment of a standard coordinate system to Data Set 1 (as shown in FIG. 5.0) with the CCE element as origin (0,0).

FIG. 5.2 shows a subsequent assignment of a standard coordinate system to Data Set 2 (as shown in FIG. 5.0) with the CCE element as origin (0,0).

FIG. 6.0 shows an example spreadsheet in which a “Copy Paste” operation will be performed.

FIG. 6.1 shows the results of the “Copy Paste” operation performed on the data spreadsheet in FIG. 6.0.

FIG. 6.2 shows a “Copy Paste” Operation Flow Chart for a Search Region in a User-specified Column.

### DETAILED DESCRIPTION

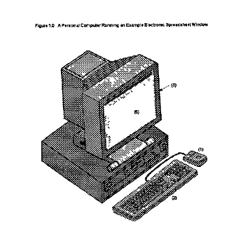

For a detailed understanding of the invention, reference is made to FIGS. 1.0 through 6.2.

The Personal Computer System and Spreadsheet Application Program

FIG. 1.0 shows an illustration of a typical computer system with a mouse (1), keyboard (2), display screen (3), and CPU (4) running an example electronic spreadsheet window (5). The mouse (1) and keyboard (2) allow the user to interface and input instructions for data manipulation in the example electronic spreadsheet and display the results on the display screen (3).

The Conventional Spreadsheet Reference Style

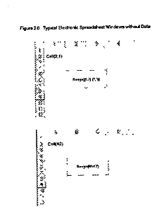

The identification of spreadsheet cells is necessary when applying spreadsheet data operations, since it is the cells in a spreadsheet that are typically used to store input data. The conventional reference style for a spreadsheet cell is of the format Cell (Row No.,Column No.) or Cell(Column Letter Row No.). FIG. 2.0 shows examples of electronic spreadsheets, where the intersection of rows and columns make up the cells in the spreadsheet. For example, the intersection of Row 2 and Column 1 forms Cell(2,1), while Column A and Row 2 make up Cell(A2).

In addition, the conventional reference style can be used to select a range of cells with a general format of Range(Upper Left Cell:Lower Right Cell). FIG. 2.0 shows an example range of cells highlighted with a dotted rectangle Range[(5,2):(7,3)] or Range (B5:C7). Although the conventional style allows a range of cells to be selected, the range cannot selectively group the cells based on the cells' content.

The Key Identifier (Key-ID)

The Key-ID is a cell content identifier. It is simply a user defined symbol, number, alphanumeric character or text string (letter, word, phrase, etc.). The user can specify the Key-ID to be the entire content or part of the content in a cell or group of cells. The Key-ID is either drawn from the original database or inserted by the user through manual spreadsheet data operations or through simple programming.

The Key-ID is used to separate the data in a spreadsheet into data sets that have the same kind of data construct. The Key-ID will allow a computer program to overcome the difficulties in dealing with databases of different format or structure by separating the spreadsheet data into manageable data sets, in which operations can be performed automatically.

Region Identifier (Region-ID)

The Region-ID is a user specified region (containing the Key-ID), which can be within one or more spreadsheets, and can be defined by up to four location identifiers namely: (a) Row or Column Identifier (RC-ID), (b) Worksheet Identifier (Sheet-ID), (c) Spreadsheet File or Workbook Identifier (File-ID) and (d) Directory Identifier (Directory-ID). In specifying the RC-ID, the user must either specify columns with letters (A, B, C, E, etc.) or rows with numbers (1, 2, 3, 4, etc.). Moreover, when the RC-ID is a wildcard (‘*’), the specified region becomes the entire sheet.

The Region-ID is represented as:

Region-ID=RC-ID, [Sheet-ID], [File-ID], [Directory-ID]

where the RC-ID is a required parameter and the Sheet-ID, File-ID, and Directory-ID are optional and not limited to only one specification. This is illustrated using the following explanations:

1) If the user specified region is located in the active sheet, the Region-ID equals RC-ID.

2) If the user specified region extends to other worksheets besides the active sheet within the active file, all the designated worksheet name or names must be specified in the Sheet-ID. In this case: Region-ID=RC-ID, Sheet-ID.

3) If the designated worksheet(s) is/are not located in the active spreadsheet file, all the file and directory names need to be specified in the File-ID and Directory-ID, respectively. In this case: Region-ID=RC-ID, Sheet-ID, File-ID, Directory-ID.

It is the incorporation of the Region-ID into the Cell Collection Expression, to be illustrated later by example, which enhances cell representation or identification.

Key-ID Selection or Insertion

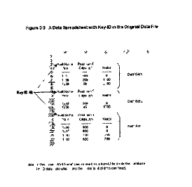

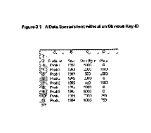

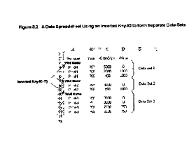

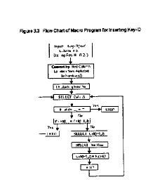

FIGS. 3.0 through 3.2 illustrate the use of the Key-ID and its effectiveness by a few examples. For the purposes of illustration and ease of visualizing the automated data manipulation method, each example contains only a limited number of data sets, each of which contains a fairly simple pattern. Although in these examples, manual processing of the data is feasible with prior art operations. In actual applications of this method, data is stored in many files and typically contains a very large number of data sets, each of which is composed of a complex pattern, rendering manual processing impractical.

FIG. 3.0 shows an example data spreadsheet containing production data for three producing oil wells. In this example, the format of the data naturally supports the use of the text ‘Well Name’ as the Key-ID (6), since the text ‘Well Name’ already identifies three different data sets with a similar data pattern.

On the other hand, FIG. 3.1 shows a data spreadsheet without an obvious Key-ID. Therefore a Key-ID has to be inserted into the spreadsheet to separate the database. In this example, the user inserts a new row containing the text ‘Well Name’ whenever there is a change of cell content in Column A, beginning from Row 2. FIG. 3.2 shows the results of the Key-ID insertion, in which ‘Well Name’ becomes the inserted Key-ID (7). This figure clearly illustrates how the insertion of the Key-ID has partitioned the database into three data sets.

The insertion of the Key-ID can generally be automated through simple prior art macro execution. FIG. 3.3 shows a flow chart of a sample macro program, which allows the user to insert the Key-ID based on the content change of a cell for a specified column.

Cell Collection Expression (CCE)

The CCE is a new concept and can be viewed as a generalized method of spreadsheet cell representation or identification, which incorporates the Key-ID and Region-ID. Cell identification with the conventional reference style is limited by the fact that a cell can only be identified using a Row No. and Column No. (e.g. Cell (2,1), Cell(12,5), etc.), or Column Letter and Row No. (e.g. Cell(A2), Cell(E12), etc.), and a range of cells can only be identified by the use of a range in a format Range(Upper Left Cell:Lower Right Cell). The CCE removes this limitation by use of a single expression to represent or identify a collection of cells, which contain the Key-ID in the cells' content.

A CCE of format Cell(Key-ID,Region-ID) is defined by the user, with one identifier as the Key-ID and the other as the Region-ID. The Region-ID specifies the region (containing the Key-ID), which is defined by the RC-ID and optional identifiers such as the Sheet-ID, File-ID, and Directory-ID. The CCE represents or identifies all those cells containing the Key-ID within the user specified Region-ID. Additionally, each cell represented or identified by the CCE is called a CCE element.

Comparison—CCE vs. Conventional Spreadsheet Reference Style for Cell Identification

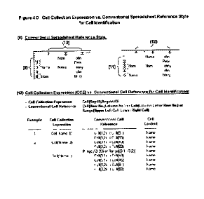

FIG. 4.0 shows a few examples illustrating the differences between the CCE and the conventional spreadsheet reference style for cell identification. (8) shows the general spreadsheet display and cell contents. The conventional spreadsheet reference style identifies a cell or group of cells based on the intersection of the Row No.(s) (9) and Column No.(s) (10), or Row No.(s) (11) and Column Letter(s) (12).

The comparison of cell identification between the CCE and conventional cell reference style is explained in (1 3) using the example cell diagrams in (8).

In Example 1, the CCE Cell(‘Name’,B) refers to all cells in Column B, which contain the text ‘Name’. This allows the CCE Cell(‘Name’,B) to represent a collection of two different cells, both containing the text ‘Name’, in a region defined by the RC-ID as Column B. While using the conventional reference style, each cell would have to be individually identified using notation such as Cell(1,2)/Cell(B1) and Cell(3,2)/Cell(B3). Note that the typical spreadsheet ‘Range’ notation cannot be used to represent this collection of cells.

In Example 2, the CCE Cell(‘Name’,3) refers to all the cells in Row 3, which contain the text ‘Name’. In this case the CCE represents a collection of two different cells, containing the text ‘Name’, in a region defined by the RC-ID as Row 3. The conventional reference style can identify these cells as Cell(3,1)/Cell(A3), Cell(3,2)/Cell (B3), or Range(A3:B3). Although Range(A3:B3) is a single expression identifying these cells, the CCE has greater flexibility in that the cells are identified using their content-‘Name’.

In Example 3, the CCE Cell(‘Name’,*) refers to all the cells in the entire sheet, which have content ‘Name’. In this example the Region-ID is defined by a RC-ID equal to ‘*’, which is a wild card representing a region encompassing the entire sheet. The CCE Cell(‘Name’,*) represents four conventional cell references: Cell(3,1)/Cell(A3), Cell (5,1)/Cell(A5), Cell(1,2)/Cell(B1), and Cell(3,2)/Cell(B3). Once again the typical spreadsheet ‘Range’ notation cannot be used to represent this collection of cells.

It is evident from these three simple examples, that the CCE has much more flexibility in that it can selectively group the cells based on the cells' content.

Data Partitioning and Processing Using the Key-ID, Region-ID and CCE

The Key-ID allows the partitioning of the spreadsheet into data sets with the same data pattern. This is accomplished by first choosing an appropriate Key-ID, which identifies each data set. Next, the user specifies the Region-ID, which specifies the region containing the Key-ID in the database. The incorporation of the Key-ID and Region-ID in the CCE allows the representation or identification of all cells containing the Key-ID. Each of these cells is a CCE element, which will be used to specify the position of target cells for spreadsheet operations using relative coordinates.

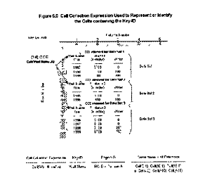

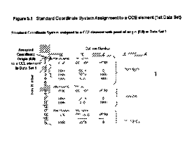

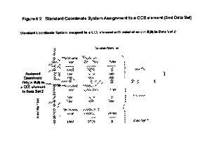

FIG. 5.0 shows the use of the CCE to represent or identify all the Key-ID cell locations for each data set. In this example, the text ‘Well Name’ is contained in each data set and is a convenient choice for the Key-ID. The CCE Cell(‘Well Name’,A), as shown in (14), has a Key-ID-‘Well Name’ and a Region-ID defined by RC-ID-Column A for the active sheet. The CCE represents the three cells in Column A (Cell(3,1), Cell (10,1), and Cell(16,1)) containing the text ‘Well Name’ (Key-ID). Each cell location, containing the Key-ID, is a CCE element to be used as a point of origin in the corresponding data set, and will form a base for automated spreadsheet operations.

The assignment of a coordinate system with origin (0,0) to a CCE element, as applied to this example (shown in FIG. 5.0), is illustrated in FIGS. 5.1 and 5.2. The Key-ID cell location contained in each data set is the CCE element for that data set. Given that every data set has the same data pattern, the relative locations of the target cells (source and/or destination cells) with respect to the data set origin (0,0) will be the same for each data set. The advantage of this method is that once the desired operations have been specified for a single data set, the same specifications can be automatically applied to all other subsequent data sets.

Note that the coordinate system is assigned to the CCE element in each data set of interest. In FIG. 5.1, the data set of interest is Data Set 1, so (0,0) corresponds to the cell location in Data Set 1 containing the Key-ID, namely Cell(3,1) in FIG. 5.0. Operations performed on Data Set 1 are specified according to this relative coordinate system. In FIG. 5.2, Data Set 2 is the data set of interest, so (0,0) in this new coordinate system corresponds to Cell(10,1) in FIG. 5.0 and is the cell in Data Set 2 containing the Key-ID. Operations performed on Data Set 2 will use this new coordinate system. The procedure will be the same for the remaining data set. As illustrated by these examples, if the relative location of the target cells for each data set is the same, then the user only has to define the CCE, relative locations of the target cells, and desired operation for one data set. All other subsequent data sets will be processed systematically.

Data Manipulation Example

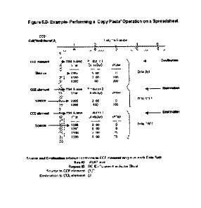

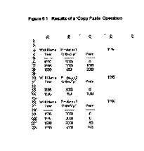

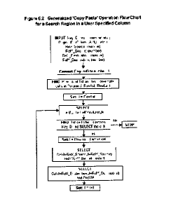

The use of the CCE to manipulate a database will now be demonstrated by an example. Consider FIG. 6.0, which shows the spreadsheet from FIG. 5.0 with the Key-ID, Region-ID, and CCE as defined in the previous examples. The objective will be to copy the first production year (source) of each well for each data set and paste it to the location two cells to the right of the producer name (destination).

First note that the source cell is located in the same column and three rows below the CCE element in each data set. Using the relative coordinate notation with respect to the CCE element, this is expressed as (3,0). The destination cell, located in the same row and three columns to the right of the CCE element, is expressed as (0,3).

The data operations to be performed by the computer are as follows:

(a) Locate the first data cell location represented by the CCE element in Data Set 1, which contains the Key-ID-‘Well Name’.

(b) Assign a standard coordinate system so that the origin (0,0) is located at the CCE element of the current data set.

(c) Copy the contents of the source cell at position (3,0), which is relative to the CCE element origin.

(d) Paste the contents into the destination cell at position (0,3), which is relative to the CCE element origin.

(e) Locate the next CCE element and repeat (b) to (e) until all data sets have been processed.

FIG. 6.1 shows the result of the ‘Copy Paste’ operations in this example after all data sets have been processed.

The last example clearly illustrates that once the CCE, spreadsheet operation and source and/or destination cells have been specified, all data sets can be automatically processed using built-in programs or macros.

This automated data manipulation method for the ‘Copy Paste’ operations, for a user specified search region, is illustrated in the flow chart shown in FIG. 6.2.

Finally, to further elaborate on the innovative nature of this invention the CCE, target cells, and type of spreadsheet data operation can form a collection of standard input parameters, which are independent of the number and absolute location of the data sets. This standard input format allows a series of user-specified data operations to be recorded and saved as a ‘batch job’ for future execution on any data file containing data sets of the same format.

1. A computer spreadsheet application method comprising of a:
Key Identifier (Key-ID) to organize and separate any database into several manageable data sets, which have similar data construct. The Key-ID is a cell content identifier. It is simply a symbol, number, alphanumeric character or text string (letter, word, phrase, etc.) that is either:
the entire content or part of the content of an existing cell or group of cells identified in the original database or,
a new Key-ID defined and inserted into the database by the user through manual spreadsheet data operations or through simple programming.

2. A computer spreadsheet application method of claim 1 further comprising of a:
Region Identifier (Region-ID) to specify the region containing the Key-Id in a single spreadsheet or plurality of spreadsheets and where,
the region of interest is defined using the Row or Column Identifier (RC-ID) and optional Identifiers-Sheet Identifier (Sheet-ID), File Identifier (File-ID), Directory Identifier (Directory-ID):

3. The computer spreadsheet application method of claim 1 and 2, further involving the use of a Cell Collection Expression (CCE) to represent or identify a cell or group of cells, which contain the Key-ID in the cells” content. The method comprising of the:
creation of a CCE with two identifiers Key-ID and Region-ID, of format Cell(Key-ID, Region-ID) defined by the user,
use of the a CCE element, which is each cell location containing the Key-ID within a manageable data set, as a reference point for a standard coordinate system,
use of patterning logic to assign a standard coordinate system to each data set with the CCE element as origin (0,0),
use of the same CCE element origin (0,0) for every data set to assign the relative locations of the target cells (source and/or destination cells) with respect to the origin,
an incorporation of a single CCE, in conjunction with the patterning logic used to identify the target cells, in prior art operations (i.e. copy, paste, insert, move, etc.) to automatically manipulate each data set within the database.
